(19) United States
(12) Patent Application Publication
(10) Pub. No.: US 2019/0141028 A1
(43) Pub. Date: May 9, 2019

(54) System and Methods for Authentication and/or Identification

(71) Applicants: Andrew Grant Lind, Auckland (NZ); Jyl Debra Anne Lind, Auckland (NZ)

(72) Inventors: Andrew Grant Lind, Auckland (NZ); Jyl Debra Anne Lind, Auckland (NZ)

(21) Appl. No.: 16/013,341

(22) Filed: Jun. 20, 2018

(30) Foreign Application Priority Data
Jun. 20, 2017 (NZ) 733018

(51) Int. Cl. H04L 29/06; G06T 9/00; G06K 9/00; G06F 21/36

(52) U.S. Cl. CPC H04L 63/0853; G06F 21/36; G06K 9/00926; G06T 9/00

(57) ABSTRACT

A method of authenticating a user. The method involves receiving or retrieving a request from a first user device for access to a website or access to an application program having an associated operable graphical user interface. A carrier image is generated, the carrier image comprising data identifying the request. The method then involves transmitting or sending website data or graphical user interface data of the application program to the first user device, the website data or graphical user interface data comprising the carrier image. The method receives or retrieves the carrier image data from a second user device, the carrier image data captured by the second user device and the carrier image comprising at least the data identifying the request. The method then authenticates the user to access the website or application program based on the data identifying the request.

### FIELD OF THE INVENTION

The present invention relates to systems and methods for authentication and/or identification. In particular, although not exclusively, the systems and methods enable authentication for secure systems, such as Internet-based services or websites.

### BACKGROUND TO THE INVENTION

Internet users often find authentication frustrating, cumbersome, and difficult to deal with. Inputting the often forgotten user name and password is a chore that many Internet users don't want to have to deal with.

Common advice given is to have unique usernames and/or passwords for each service or website the user may log in to. This further increases an Internet user's frustration as it becomes even more difficult to remember their username and password combinations.

Worsening this frustration is the Internet's push for two factor authentication (2FA). While the increased security is important, the increased security often does not lend itself to an easier or more streamlined authentication process. Increased security is especially important for secure systems, such as banking websites. Two factor authentication can take many forms including receiving a text message and submitting the received content to a login system, receiving an email to one of the user's multiple email addresses and submitting the received content into a login system, submitting biometric data to a login system, submitting encryption keys to a login system, and many more. Difficulty can arise when verifying a user's biometric data when the device being used to interact with the login system is not able to read biometric data.

Another alternative is to use password aggregation. This holds multiple passwords in one place, secured by a master password. However, the user is often locked into a proprietary “built-in” web browser, limiting their freedom of choice. If they choose not to use the “built-in” web browser, the user experience is compromised and clunky.

User interfaces can often be ugly, bulky and require a multitude of different interface elements. Login systems are no exception to this.

### SUMMARY OF THE INVENTION

It is an object of at least some of the embodiments of the present invention to provide an improved system and/or method of authentication and/or identification for accessing secure systems, or to at least provide the industry with a useful choice.

In a first aspect, the present invention broadly relates to a method of storing data within an image, comprising the steps of receiving or retrieving an input image, receiving or retrieving or generating the data, retrieving, receiving, or generating image mask data, wherein the image mask data comprises data indicative of a coding area of the input image, and generating a carrier image based on the input image and the data, wherein the carrier image encodes the data in the coding area of the input image.

In one embodiment, the step of generating the carrier image comprises modifying the input image such that the carrier image is a modified version of the input image.

In one embodiment, the carrier image encodes the data visually.

In one embodiment, the carrier image looks the same as, or similar to, the input image.

In one embodiment, the data is random. In one embodiment, the data is a number. In one embodiment, the data is a URL.

In one embodiment, the size of the data is a function of the input image.

In one embodiment, the coding area describes or indicates a foreground area of the input image.

In one embodiment, image mask data is generated manually by an operator.

In one embodiment, image mask data is pre-determined.

In one embodiment, the retrieving, receiving, or generating image mask data step further comprises identifying the coding area of the input image, and generating the data indicative of a coding area based on the coding area of the input image.

In one embodiment the retrieving, receiving, or generating image mask data step further comprises extracting the image mask data from the input image.

In one embodiment, the method further comprises the step of calculating a coding area size based on the data indicative of the coding area.

In one embodiment, the image mask data further comprises data indicative of a non-coding area.

In one embodiment, the retrieving, receiving, or generating image mask data step further comprises generating data indicative of a non-coding area based on the data indicative of a coding area.

In one embodiment, the method further comprises the step of calculating a non-coding area size based on the data indicative of the coding area.

In one embodiment, the retrieving, receiving, or generating image mask data step further comprises generating data indicative of a non-coding area based on the background of the image.

In one embodiment, the coding area comprises at least one disjointed sub-areas.

In one embodiment, the coding area comprises one continuous sub-area.

In one embodiment, the method further comprises the step of calculating a coding area size based on the data indicative of the coding area.

In one embodiment, the coding area comprises a plurality of colour units.

In one embodiment, a colour unit is one of the following: pixel, pixel group, vector, or object.

In one embodiment, the image mask data comprises a coding area size and the size of the coding area is the sum of colour units within the coding area.

In one embodiment, a size of the data is a function of a size of the coding area.

In one embodiment, the data comprises a plurality of codewords, wherein the codewords belong to an alphabet.

In one embodiment, the data is encoded data and has been pre-encoded according to an encoding scheme comprising an alphabet.

In one embodiment, the method further comprises the step of encoding the data according to an encoding scheme to generate encoded data, wherein the encoding scheme comprises an alphabet.

In one embodiment, the encoded data comprises a plurality of codewords. Preferably the codewords belong to the alphabet.

In one embodiment, the encoding scheme is a binary-to-text encoding scheme. In one embodiment, the encoding scheme is hexadecimal, binary, octal, Base32, or Base64.

In one embodiment, the size of the alphabet is variable.

In one embodiment, the size of the alphabet of the encoding scheme is user-selectable.

In one embodiment, the size of the alphabet is based on any one or more of the following:

size of the data, size of the encoded data, the number of codewords, the size of the input image, input mask data, and/or data indicative of the coding area.

In one embodiment, the step of generating the carrier image comprises generating colour data based on the data and a colour map, and inserting colour data into the coding area of the carrier image.

In one embodiment, the step of generating the carrier image comprises generating colour data based on the codewords and a colour map, and inserting colour data into the coding area of the carrier image.

In one embodiment, the step of generating the carrier image comprises generating colour data based on the codewords and a colour map, comprising the step of matching the codewords with an associated colour using the colour map; and inserting colour data into the carrier image.

In one embodiment, the colour map comprises an array and the array comprises a plurality of values each identified by a key. Preferably the key is an index.

In one embodiment, the colour map comprises a plurality of key-value pairs, wherein the key-value pairs comprise a key and a value.

In one embodiment, the key represents a codeword and the value represents a colour.

In one embodiment, the key represents a colour and the value represents a codeword.

In a second aspect, the present invention broadly relates to a method of decoding carrier image data from a carrier image comprising the steps of receiving or retrieving the carrier image, extracting the carrier image data, and transmitting the carrier image data to a remote device.

In one embodiment, the receiving or retrieving step comprises capturing the carrier image using an image capture device.

In one embodiment, the extracting step further comprises receiving, retrieving, or generating a colour map, reading a plurality of colour units of the carrier image data, and for each colour unit: matching the colour unit to a encoding data point using the colour map, and storing the matched data points in memory.

In one embodiment, the matched data is the carrier image data.

In one embodiment, extracting step further comprises decoding the matched data to decoded data.

In one embodiment, the decoding step comprises the steps of receiving, retrieving, or generating an encoding scheme, decoding the encoded data using the encoding scheme.

In one embodiment, the decoded data is the carrier image data.

In one embodiment, the method further comprises the steps of receiving or retrieving the carrier image data, and verifying the carrier image data.

In a third aspect, the present invention broadly relates to a method of inserting a carrier image on a website or graphical user interface, comprising the steps of receiving or retrieving an input image, and wherein the input image is a pre-existing image, receiving, retrieving, or generating data, generating the carrier image based on the input image and the data, wherein the carrier image encodes the data, and inserting the carrier image into the website or graphical user interface.

In one embodiment, the data is a highly unique identifier.

In one embodiment, the data is a number.

In one embodiment, the data is a session id.

In one embodiment, the data is random.

In one embodiment, the size of the data is a function of the input image.

In one embodiment, the size of the data is a less or equal to than the size of the input image.

In one embodiment, the data identifies or is used to identify a browser session.

In one embodiment, the data identifies or is used to identify a TCP/IP session.

In one embodiment, the input image is a pre-existing image of the website.

In one embodiment, the input image is a pre-existing image for insertion into the website or graphical user interface.

In one embodiment, the input image is a brand image.

In one embodiment, the input image comprises visual information associated with the website or graphical user interface.

In one embodiment, the input image comprises a company logo.

In one embodiment, the brand image comprises the name of a company.

In one embodiment, the brand comprises the logo of the company that runs, hosts, or operates the website or the graphical user interface.

In one embodiment, the brand comprises the name of the company that runs, hosts, or operates the website or owns the graphical user interface.

In one embodiment, the carrier image is a modified version of the input image.

In one embodiment, the carrier image looks the same or similar to the input image.

In one embodiment, the carrier image encodes the data graphically.

In one embodiment, the input image is a pre-existing image.

In one embodiment, the data is indicative of a browser session of a user on a first device.

In one embodiment, the first device comprises or is operatively connected to an electronic display or screen.

In one embodiment, first device is any one of a desktop PC, smartphone, tablet, laptop, television, gaming console, or any other programmable device comprising a display screen.

In one embodiment, the first device displays the carrier image.

In one embodiment, the first device requests the website.

In one embodiment, the first device displays the graphical user interface.

In one embodiment, the graphical user interface is associated with the operation of an application program executable on the first device. In one form, the graphical user interface enables a user to operate the application program.

In one embodiment, the method further comprises the step of capturing the carrier image.

In one embodiment, the user captures carrier image data using a second device.

In one embodiment, the second device is a smartphone or tablet.

In another embodiment, the second device is an electronic device comprising an image capture sensor or sensors.

In one embodiment, at least one server receives or retrieves the carrier image data from the second device.

In one embodiment, at least one server receives or retrieves the carrier image data from the second device.

In one embodiment, the at least one server verifies the carrier image data.

In one embodiment, the at least one server authenticates the browser session of the user on the first device.

In one embodiment, the data is received from a webserver that served the website.

In one embodiment, the step of inserting the carrier image comprises inserting a reference to the carrier image.

In one embodiment, the reference to the carrier is in the form of an HTML image tag.

In one embodiment, the reference to the carrier image comprises a reference to an image generation server.

In one embodiment, the image generation server is configured to serve the carrier image.

In one embodiment, the reference to the carrier image comprises a reference to a web server.

In one embodiment, the web server is configured to server the carrier image and the website.

In a fourth aspect, the present invention broadly relates to a method of authenticating a user, comprising the steps of: receiving or retrieving a request from a first user device for access to a website or access to an application program having an associated operable graphical user interface, generating a carrier image, the carrier image comprising data identifying the request, transmitting or sending website data or graphical user interface data of the application program to the first user device, the website data or graphical user interface data comprising the carrier image, receiving or retrieving carrier image data from a second user device, the carrier image data captured by the second user device and the carrier image comprising at least the data identifying the request, and authenticating the user to access the website or application program based on the data identifying the request.

In one embodiment, the first user device receives the carrier image and website data or graphical user interface data. In one embodiment, the first user device displays the website or graphical user interface of the application program. In one embodiment, the first user device displays the website comprising the carrier image or graphical user interface comprising the carrier image In one embodiment, the first user device is any one of a desktop PC, smartphone, tablet, laptop, television, gaming console, or any other programmable device comprising a display screen. In one embodiment, the desktop PC, smartphone, tablet, laptop, television, gaming console, or any other programmable device comprising or operatively connected to a display screen, is used to initiate the request.

In one embodiment, the website or graphical user interface comprises a reference to the carrier image.

In one embodiment, the second user device comprises an image sensor. In one embodiment, the second user device captures the carrier image using an image sensor of the second user device. In one embodiment, the second user device captures the carrier image from the display screen of the first user device. In one embodiment, the second user device stores the captured image in memory. In one embodiment, the second user device extracts carrier image data from the captured carrier image. In one embodiment, the carrier image data is data representative of the carrier image. In one embodiment, the carrier image data is the data representative of the request. In one embodiment, the second user device is a smartphone or tablet, or any electronic device comprising an image capture sensor or sensors.

In one embodiment, the second user device transmits the carrier image data to a remote server. In one embodiment, the second user device transmits user data relating to the website or application program. In one embodiment, the user data is login credentials for the website or application program.

In one embodiment, the remote server is the web server serving the website or a server serving the application program. In one embodiment, the remote server is a carrier image generator. In one embodiment, the server retrieves or receives the carrier image data. In one embodiment, the carrier image generator receives or retrieves the carrier image data.

In one embodiment, the remote server verifies the carrier image data. In one embodiment, the remote server verifies the user data.

In one embodiment, the user is authenticated to the website or application program on the first user device.

In one embodiment, the authenticating step comprises logging a user into the website or application program.

In one embodiment, the first user device displays the carrier image within an operable graphical user interface associated with an application program. In one embodiment, the first user device displays a graphical user interface. In one embodiment, the first user device displays the carrier image. In one embodiment, the first user device comprises or is operatively connected to an electronic display screen configured to display the graphical user interface of the application program. In one embodiment, the first user device is any one of a desktop PC, smartphone, tablet, laptop, television, gaming console, or any other programmable device comprising a display screen. In one embodiment, the first user device is used to initiate the request.

In one embodiment, the displayed graphical user interface comprises a reference to the carrier image.

In one embodiment, the second user device comprises an image sensor. In one embodiment, the second user device captures the carrier image using an image sensor of the second user device. In one embodiment, the second user device captures the carrier image from the display screen of the first user device. In one embodiment, the second user device stores the captured image in memory. In one embodiment, the second user device extracts carrier image data from the captured carrier image. In one embodiment, the carrier image data is data representative of the carrier image. In one embodiment, the carrier image data is the data representative of the request. In one embodiment, the second user device is a smartphone or tablet, or any electronic device comprising an image capture sensor or sensors.

In one embodiment, the second user device transmits the carrier image data to a remote server. In one embodiment, the second user device transmits user data relating to the application program. In one embodiment, the user data is login credentials for the application program having the associated graphical user interface.

In one embodiment, the remote server is a carrier image generator. In one embodiment, the server retrieves or receives the carrier image data. In one embodiment, the carrier image generator receives or retrieves the carrier image data.

In one embodiment, the remote server verifies the carrier image data. In one embodiment, the remote server verifies the user data.

In one embodiment, the user is authenticated to the application program on the first user device.

In one embodiment, the authenticating step comprises logging a user into the application program.

The fourth aspect above may have any one or more of the features of the third aspect above.

In a fifth aspect, the present invention broadly relates to a system comprising a server comprising a processor, and a computer-readable storage medium having stored thereon instructions which, upon being executed by the processor, cause the system to execute or implement the method of any one of the first-fourth aspects.

In a sixth aspect, the present invention broadly relates to a computer-readable medium having stored thereon computer executable instructions that, when executed on a processing device or devices, cause the processing device or devices to perform a method of any one of the first-fourth aspects.

In a seventh aspect, the present invention broadly relates to a set of application program interfaces embodied on a computer-readable medium for execution on a processing device in conjunction with an application program that conducts the method of any one of the first-fourth aspects.

Other aspects of the invention are described in the following paragraphs:

In one aspect, the invention broadly comprises a method of storing data within an image, comprising the steps of receiving or retrieving an input image, receiving or retrieving or generating the data, retrieving, receiving, or generating image mask data, wherein the image mask data comprises data indicative of a coding area of the input image, and generating a carrier image based on the input image and the data, wherein the carrier image encodes the data in the coding area of the input image.

In one aspect, the invention broadly comprises a method of decoding carrier image data from a carrier image comprising the steps of: receiving or retrieving the carrier image, extracting the carrier image data, and transmitting the carrier image data to a remote device.

In one aspect, the invention broadly comprises a method of inserting a carrier image on a website, comprising the steps of: receiving or retrieving an input image, and wherein the input image is a pre-existing image, receiving, retrieving, or generating data, generating the carrier image based on the input image and the data, wherein the carrier image encodes the data, and inserting the carrier image into the website.

In one aspect, the invention broadly comprises a method of authenticating a user, comprising the steps of: receiving or retrieving a request for a website from a first user device, generating a carrier image, the carrier image comprising data identifying the request, transmitting or sending the website to the first user device, the website comprising the carrier image, receiving or retrieving carrier image data from a second user device, the carrier image data captured by the second user device and the carrier image comprising at least the data identifying the request, and authenticating the user to the website based on the data identifying the request.

In one aspect, the invention broadly comprises a system comprising a server comprising: a processor, and a computer-readable storage medium having stored thereon instructions which, upon being executed by the processor, cause the system to execute or implement the method of the previous aspects.

In one aspect, the invention broadly comprises a computer-readable medium having stored thereon computer executable instructions that, when executed on a processing device or devices, cause the processing device or devices to perform a method of any one of the previous aspects.

In one aspect, the invention broadly comprises a set of application program interfaces embodied on a computer-readable medium for execution on a processing device in conjunction with an application program that conducts the method of any one of the previous aspects.

Any of the features of one aspect may apply to the other aspects above.

The phrase “computer-readable medium” as used in this specification and claims should be taken to include a single medium or multiple media. Examples of multiple media include a centralised or distributed database and/or associated caches. These multiple media store the one or more sets of computer executable instructions. The phrase ‘computer readable medium’ should also be taken to include any medium that is capable of storing, encoding or carrying a set of instructions for execution by a processor of a computing device and that cause the processor to perform any one or more of the methods described herein. The computer-readable medium is also capable of storing, encoding or carrying data structures used by or associated with these sets of instructions. The phrase ‘computer-readable medium’ includes solid-state memories, optical media and magnetic media.

The term “server” as used in this specification and claims refers to any computerized component, system or entity regardless of form which is adapted to provide data, files, applications, content, or other services to one or more other devices, processes, modules, components, functions, or other similar entities. The term “server” includes physical servers, virtualised servers, microservices, and computer processes running on any of the preceding.

The term “brand” as used in the specification and claims refers to any image, text, combination of image and text, and/or other image, logo, or asset capable of visually identifying a company, organisation, good and/or service.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1A is an overview of a carrier image generation system;

FIG. 1B is an overview of another carrier image generation system;

FIG. 1C shows a high-level layout of the carrier image generator;

FIGS. 2A-2D show example brands;

FIGS. 3A and 3B show example image masks;

FIGS. 4A and 4B shows an example data generation methods;

FIG. 5 is an example highly unique identifier;

FIG. 6 is an example data encoding method;

FIG. 7 is an example colour insertion method;

FIG. 8 shows an example carrier image generation system;

FIG. 9A is an example brand;

FIG. 9B is an example image mask;

FIG. 9C is an example carrier image;

FIG. 10 shows an example network authentication system;

FIG. 11 shows a high-level layout of a carrier image generator; and

FIG. 12 shows a high-level layout of a user device.

### DETAIL DESCRIPTION OF PREFERRED EMBODIMENTS

In the following description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described below may be operable on any type of general purpose computer system or computing device, including, but not limited to, a desktop, laptop, notebook, tablet, smart television, or mobile device. The term “mobile device” includes, but is not limited to, a wireless device, a mobile phone, a smartphone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, short-range radio, cellular etc.).

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Overview

An embodiment of the invention relates to a method of inserting a “carrier image”, which is based from or off a pre-existing image. The inserting may be in the form of replacing, updating, modifying, overwriting the pre-existing image with the carrier image, or referencing. This system is called an “image insertion system”, because the carrier image may be “inserted” into another medium. Optionally, the carrier image may be inserted in place of where the pre-existing image would have gone. Optionally the pre-existing image may never have been used previously, and merely serves as an input. The carrier image comprises data. The carrier image “carries” data visually. The carrier image is based on the pre-existing image, or the carrier image is a modified version of the pre-existing image. In some embodiments, the carrier image looks the same or similar to the pre-existing image. Optionally, the input image may be modified to carry the data and thus becomes a carrier image.

A user, with an electronic device that is capable of capturing or sensing the carrier image, is then able to extract the data from the image. Users who are not aware that the carrier image may contain information will ignore the carrier image and view it just as they would if it were the pre-existing image.

In one aspect, this image insertion system may be used in combination with a user login and/or network authentication system.

A further embodiment relates to methods and systems relating to the creation of the carrier image. Carrier images comprising data are called carrier images because they “carry” the data with them. The method of creating the carrier images results in a carrier image looking the same or similar to an input image. Optionally, the input image may be modified to carry the data and generate a carrier image. In some embodiments, the carrier image may be the same or similar to the input image based on same or similar colours, same or similar shape, or both.

The data held within the carrier image is then extracted by a receiving device. The data may be arbitrary. The data may comprise any one or more of the following, in any combination, and in any count:
number,
URL,
metadata,
random number,
random data,
highly unique identifier,
serial number,
session ID number,
TCP/IP connection data, optionally including the session ID,
customer number, and/or
database key.

A person skilled in the art will appreciate that the arbitrary data can comprise any other information. Optionally, the data may only contain just one piece of information.

Having a carrier image that looks visually similar to an input image but also carries, or is encoded with, information has many applications. In one aspect, this embodiment may be used in an image insertion system.

The carrier image generator 150 may be a single device, or comprise a number of devices. Preferably, the carrier image generator 150 is a server.

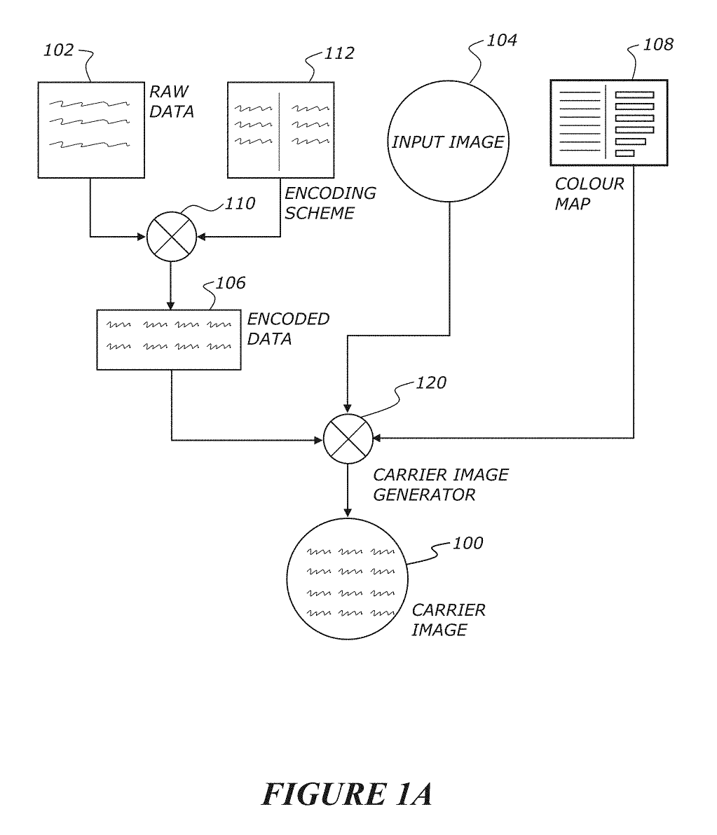

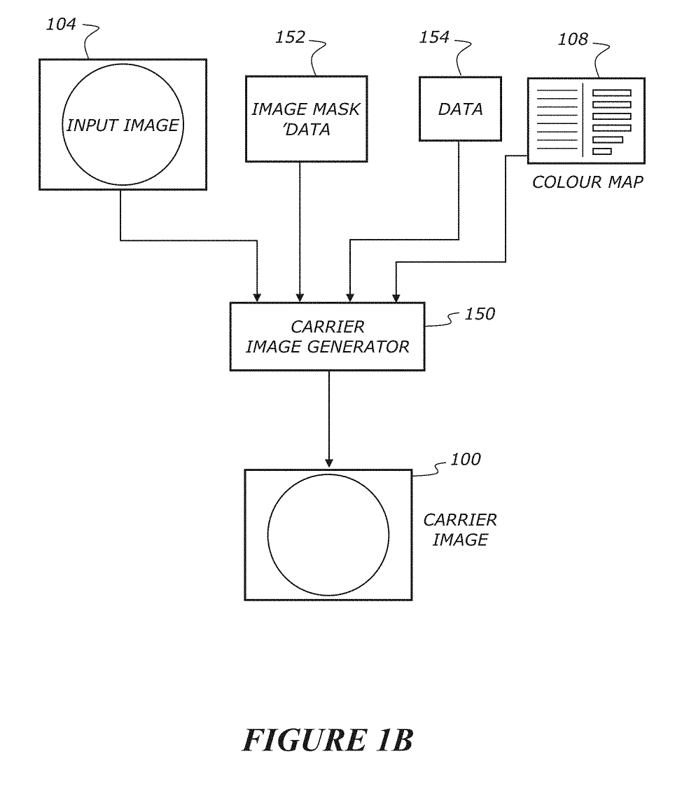

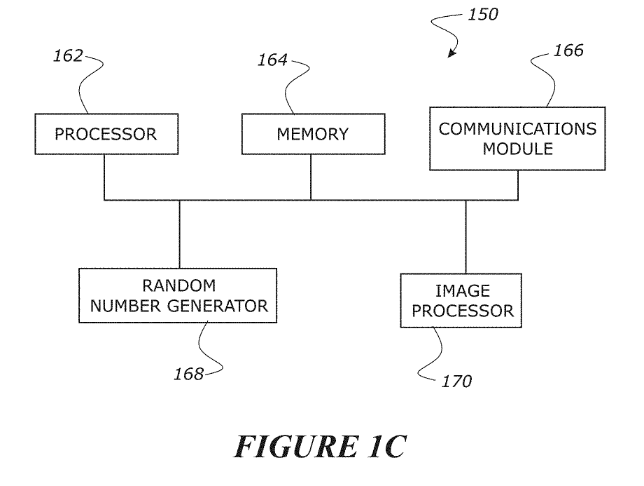

FIG. 1C details the carrier image generator. The carrier image generator 150 may comprise a processor 162, memory 164, a communications module 166, a random number generator 168, and an image processor 170.

The processor 162 may be used to run instructions stored in the memory 164. The communications module 166 may be a network interface such as Ethernet or Wi-Fi. The communications module 166 may be any module capable of establishing a connection and/or communicating with other devices, processes and/or servers. A person skilled in the art will appreciate that servers have a number of ways to communicate with other devices. Including, but not limited to APIs, RPCs, REST APIs, plugins, Inter-Process Communication (IPC), file systems, HTTP transmissions, or TCP transmissions. Some or all of these may require a communications module 166. The memory 164 may be any computer-readable storage medium.

The random number generator 168 may be a pseudorandom number generator. The random number generator 168 may be used to generate data when there is no data present, or the data 154 provided indicates that random data should be generated. Optionally, the data 154 used in the carrier image 100 may be also provided as an output along with the carrier image 100. Similarly, the colour map 108 may also be provided as an output from the carrier image generator 150.

Carrier Image

FIG. 1A shows a high-level schematic view of an embodiment of the end-to-end process of creating the carrier image 100.

The carrier image generation algorithm or system 120 has three main inputs:
raw data 102 or encoded data 106,
an input image 104, and
a colour map 108.

All of these inputs may be received, retrieved, and/or predetermined.

The encoded data 106 may need to be calculated, or generated, based on raw data 102 according to an encoding scheme 112 as shown in the encoding step 110. The encoding scheme 112 may be received, retrieved, and/or predetermined. The raw data 102 may be received, retrieved, and/or generated. The encoding step 110 is optional. In some embodiments, the raw data 102 is directly encoded into the carrier image 100. Embodiments, encoded data 106 represents the raw data 102 and is encoded into the carrier image 100.

By way of example, the input image 104 may be an image for use on a web page or a graphical user interface of an application program. The input image 104 may be for use on a login web page to access a secure system, such as an Internet banking website, or e-commerce, or financial website, or for display in a login screen of a graphical user interface associated with an application program. The input image 104 may be a brand or logo for example. A skilled person will appreciate that even if an input image 104 itself is not for use on the web page, using a carrier image 100, which is visually similar to the input image, constitutes the use of the input image 104 at an abstract layer since they are visually the same or similar.

The encoded data 106 comprises or represents the raw data 102. The encoded data 106 encodes the raw data 102. The use of “data” 102 in the specification may refer to the encoded data 106 or the data itself 102, or raw data. Optionally, the raw data 102 may already be encoded according to an encoding scheme 112 and as such a method according to this embodiment may not require encoding the raw data 102 further. It will be appreciated by a person skilled in the art that raw data 102 may be moved to an encoded state (as encoded data 106) and then to a decoded state (as raw data 102) arbitrarily where required. The raw data 102 and/or encoded data 106 may comprise codewords.

The carrier image generation 120 may modify the input image 104 such that the carrier image 100 is a modified version of the input image 104.

The carrier image 100 comprises the raw data 102. In this example, the carrier image 100 comprises the encoded data 106, which represents or encodes the raw data 102. The carrier image 100 encodes the raw data 102 visually. The carrier image 100 may encode the raw data 102 using the visual data of the carrier image 100. In this example, the carrier image 100 encodes the encoded data 106 visually. Further, the carrier image 100 encodes the encoded data 106 using the visual data of the carrier image 100.

For example, the colour of a colour unit within the carrier image 100 may represent the raw data 102. Alternatively, the colour of a colour unit may represent part of the data and a grouping of many colour units may represent the raw data 102. An example colour unit is a pixel. A colour unit need not have any colour. A colour unit may be black and white and/or greyscale. A colour unit may also have other sundry information associated with it. For example, transparency and/or size.

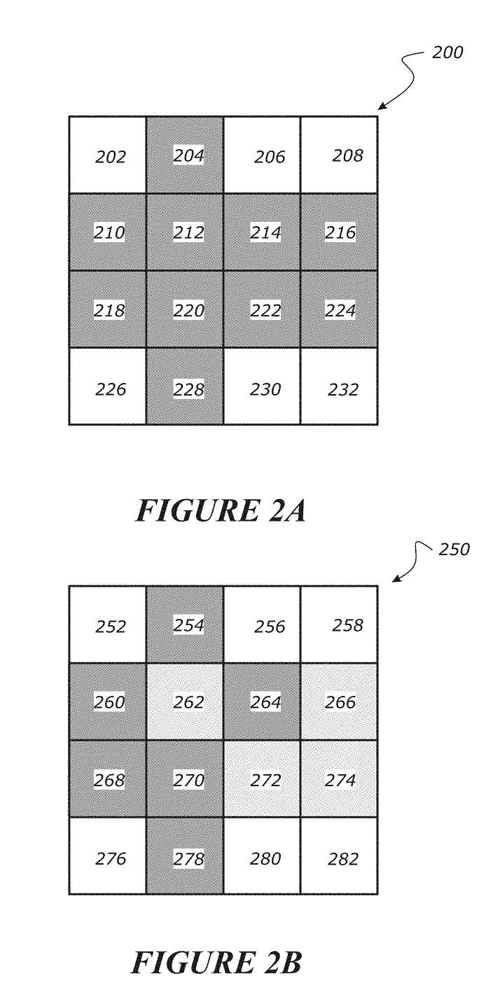

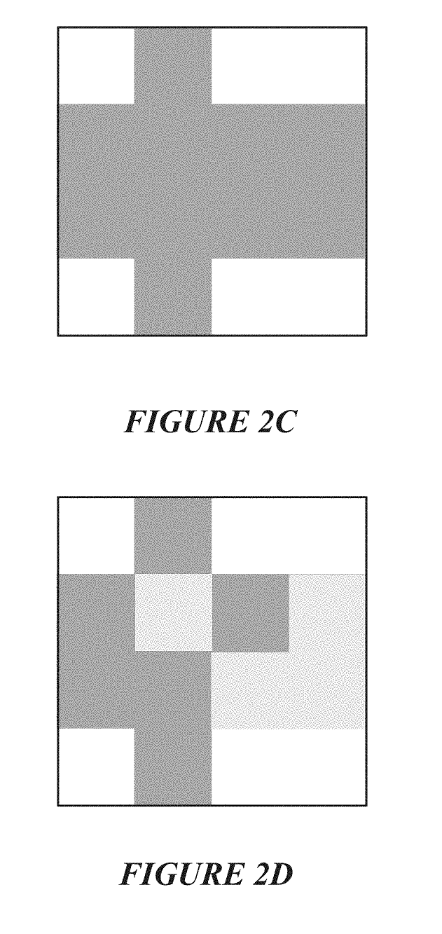

FIG. 2A shows an example input image 200. This example input image 200 is a raster graphics image as shown by its make-up of pixels 202-232 located within the image perimeter, boundary, or border. The example of the image 200 comprises a very simple brand and a background. Optionally the input image may comprise only a brand and/or no background. The brand is made up of the pixels 204, 210, 212, 214, 216, 218, 220, 222, 224, 228. The background is made up of the remaining pixels 202, 206, 208, 226, 230, 232.

The example input image 200 has been chosen for its simplicity for ease of describing the method of this embodiment. It will be appreciated that colour or more complex shapes may also be used. Further, it will be appreciated by person skilled in the art that more complex example images comprising more colours and more pixels may be used in a similar fashion.

FIG. 2B shows an example carrier image 250. The carrier image 250 looks visually similar to the input image 200. The carrier image's 250 change in colouration has been accentuated for clarity purposes so that a reader can clearly see the pixels have changed colour. A real-world system may use colour other than grey scale. A real-world system may also use more similar colours from input image 200 to carrier image 250. Ideally, the colour selection will mean a user viewing the image cannot easily make out the difference between the input image 200 and the carrier image 250, but an image capture device with an image processor can.

The carrier image 250 clearly has the same brand comprised in the pixels 254, 260, 262, 264, 266, 268, 270, 272, 274, 278 as the input image 200. The carrier image 250 now comprises data. The data is expressed in the pixels of the carrier image 250. As such, the data has been visually encoded in the image.

Raster graphics images are used throughout the specification for convenience only. Vector graphics images may also be used in a similar fashion as these raster graphics images. A person skilled in the art will appreciate how to modify raster graphics images techniques disclosed to work with vector graphics images. For example, converting a raster graphics image to a vector graphics image is known as vectorisation, and converting a vector graphics image to a raster graphics image is called rasterization.

The black lines shown in FIGS. 2A and 2B are used to represent pixel boundaries. These black lines are not part of the brand, input image 200, and/or carrier image 250.

FIG. 2C shows an example of what the input image 200 looks like without the pixel boundary lines obscuring the image.

FIG. 2D shows an example of what the carrier image 250 looks like without the pixel boundary lines obscuring the image.

Carrier Image Generation

In this embodiment, the carrier image generation step 120 comprises any one or more the following steps, performed at any time, and in any combination:
receiving, retrieving, or generating image mask data,
encoding the data into codewords (if not already encoded),
mapping the codewords of the encoded data to colours,
inserting the colours into the carrier image 100.

As discussed above, a purpose of the carrier image generation step 120 is to generate a carrier image 100 that both is visually similar to the input image 104 and encodes the raw data 102 visually.

FIG. 1B describes as an alternative carrier image generation system. This carrier image generation system comprises an input image 104, image mask data 152, data 154, a colour map 108, a carrier image generator 150, and a carrier image 100. In this example the data 154 may be optional and/or be indicative of requiring the carrier image generator 150 to generate random data.

The carrier image generator 150 receives the input image 104, input mask data 152, data 154, colour map 108 as inputs and outputs a carrier image 100. The data 154 may be received as encoded data or raw data. If received as raw data, the carrier image generator may encode the data 154 according to an encoding scheme. In this case the encoded data will comprise codewords. Optionally, the data 154 may comprise codewords.

The image processor 170 may be used to generate the carrier image 100. The image processor may be implemented as instructions to be stored in memory 164 and run by the processor 162. Alternatively, the image processor 170 may be a remote device, or a co-processor capable of generating images. The image processor 170 may be able to insert pixels into an image. For example, the image processor 170 may receive an input image and insert additional pixels to overwrite the input image. In another example, the image processor 170 may generate an entirely new image and insert pixels based on the input image.

The colour map 108 comprises map between codewords and colours.

Image Mask

Image mask data is associated with at least one input image. The image mask data describes, represents or identifies area(s) or region(s) of the input image 104. The image mask data provides a useful way to separate, nominate, identify, and/or use different area(s) of the input image 104. The area or areas of the input image that the image mask data separates, nominates, identifies, and/or uses are for defining that area or areas to be encoded with data. In one embodiment, the image mask data defines or describes a coding area of the input image. Throughout the specification a foreground and background areas have been used for illustrative purposes, wherein the foreground is used as the coding area and the background is used as the non-coding area. In one embodiment, instead of the background and foreground, other areas may be used such as specific sections of the input image 104. In another embodiment, the areas may be the portions of a brand. For example, if the brand comprises an image and text, a coding area may be the text and the non-coding area may be the rest of the image. More than 2 areas may be used. For example, the text of a brand may be a coding area, the logo of said brand may be a non-coding area, and the background a third area. The third area may be a further non-coding area. Optionally, a coding area comprises the first and second sub-areas. A person skilled in the art will appreciate that images may be cut into a multitude of different areas arbitrarily and/or depending on the application.

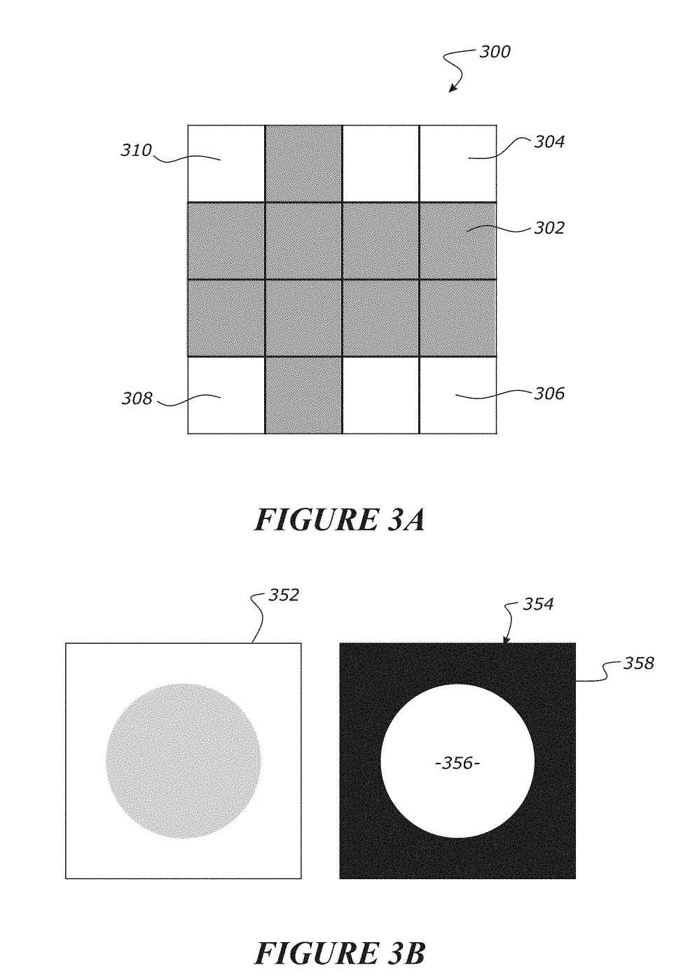

Using the example input image 200 of FIG. 2A, FIG. 3A shows an example image mask 300. The image mask 300 is a graphical representation of image mask data. In one embodiment the image mask data may be an image mask 300 the same size as the input image 200. Alternatively, the image mask data may be another in the form of data type capable of describing at least one area or region within an image, such as an array, a set of pixel co-ordinates, a bitmap, JSON data, XML data, CSV data, or otherwise. A person skilled in the art will appreciate there are many ways to describe area(s) or region(s) within an image.

The image mask data may be retrieved, received, or generated. The image mask data may be retrieved, received, or generated once per input image and optionally stored for later use. Alternatively, the image mask data may be retrieved, received, or generated for every input image. Alternatively, the image mask data may be metadata attached to the input image. The image mask data may be calculated ahead of time. For example, before the input image is processed and carrier image is to be generated.

The image mask data describes, represents, or identifies at least one or more areas within the input image 200. The image mask data may describe a coding area of the input image 200, the non-coding area of an input image 200, or both. Alternatively, the image mask data may describe a background of the input image 200, the foreground of an input image 200, or both. The area(s) or region(s) of the image mask data may comprise one or more sub-areas. These sub-area(s) may be disjointed subareas or one continuous sub-area. The image mask data may follow a predetermined or configurable standard, rule, or setting for describing or defining different types of area(s). For example FIG. 3A uses a standard where a grey pixel describes the coding area and a white pixel describes the non-coding area. The example shown in FIG. 3B uses a standard where a white pixel is used to describe the coding area and a black pixel to describe the non-coding area. In the both of the example shown in FIG. 3A and FIG. 3B, the coding area is the foreground of the image and the non-coding area is the background. Alternatively, the image mask data may further comprise data defining or representing the standard.

A vector graphics input image may comprise metadata describing which polygons and/or objects belong to which area. Alternatively, the polygons and/or objects of the vector graphics images may be tagged with which area they belong to.

The areas and/or sub-areas of the image mask data may be broken down further into colour units. These colour units may be individual pixels, pixel groups, or polygons and/or objects. Pixel groups may be 2 pixels×2 pixels, 3 pixels×3 pixels, 4 pixels×4 pixels, 1 pixels×2 pixels, 2 pixels×1 pixels or any other grouping.

In one embodiment, the image mask data describes the coding area of the input image 200. Alternatively, the image mask data describes the non-coding area of the input image 200. Alternatively, the image mask data describes both the coding area and the non-coding of the input image.

The example presented in FIG. 3A shows image mask data in the form of a mask image 300, describing a coding and a non-coding area. The pixels presented in grey describe or represent a coding area 302, while the pixels presented in white describe or represent a non-coding. The non-coding area in this example comprises a plurality of sub-areas 304, 306, 308, 310. Sub-area 304 and sub-area 306 comprise two pixels. The coding area 302 comprises 10 pixels. The coding area 302 in this example is the foreground of the input image 200 and the non coding area in this example is the background of the input image 200.

Alternative to the mask image 300 is the example JSON data:

```
{
  “image_mask_foreground_areas”: [
    [[1,0], [1,3]],
    [[0,1], [3,2]]
  ],
  “image_mask_foreground_size”: 10
}
```

The JSON data above describes the foreground area using two sub-area rectangles. The rectangles are made up of the coordinates (1, 0)×(1, 3) and (0, 1)×(3, 2). The coordinate system is in the form (X1, Y1)×(X2, Y2). The X1 and X1 coordinates define a first corner of the rectangle and the X2, Y2 coordinates define a second corner of the rectangle. In this example, the two rectangles overlap. Optionally, the rectangles may not overlap. Optionally, other shapes may be used. Adding these two rectangles to give gives the foreground of the input image 200. Optionally, the image mask data may be offset relatively to the input image and use a different origin. In this example, the image mask area size is also included. Optionally this may be calculated.

A further example is shown in FIG. 3B. The input image 352 represents a circle, which may be yellow, for example, or another colour. The image mask data 354 describes two areas. The coding area 356 in white describes or represents the foreground of input image 352 and the non-coding area 358 in black describes the background of the input image 352.

Typically, the foreground area 356 a select to be encoded with data to produce the carrier image.

The image mask data may be generated using any known image processing algorithms capable of detecting background and/or foreground. Example algorithms may include:
edge detection,
foreground/background detection,
colour detection, and/or
alpha/transparency detection.

Any number of the above algorithms may be used in any combination with each other, in aggregate, and/or by themselves to determine areas within an image.

Alternatively, the image mask data may be generated or defined manually by an operator, for example via a graphical user interface (GUI) displaying the image on a screen on which the operator may identify, trace, or otherwise generate the mask data via user interaction with the GUI.

The image mask data may comprise the size(s) of area(s) within of the image mask data. Alternatively, the size(s) of the area(s) within the image mask data size may be calculated based on the image mask data. The size may be calculated by summing the number of colour units in each area.

For example, the size of the foreground area of image mask 300 is ten because colour unit of the input image mask data is a pixel and there are ten pixels in the foreground area.

The size(s) of the area(s) may be stored for later use, presented to another process, or directly used to generate the data.

Data and Encoding

Another step in the carrier image generation 120 is receiving, retrieving, or generating raw data 102. The raw data 102 received, retrieved, or generated may be based on the size(s) of the area(s) in the image mask data. The raw data 102, or an aspect of the data may be a function of the size of an area defined by the image mask data. For example, the size criteria of the data may be a function of the size of the image area defined or identified. For example, in one embodiment the system is configured such that the size of the data may not exceed the size(s) of the area(s) in the image mask data. More specifically in this embodiment, the raw data 102 is restricted to being of a size that is less than or equal to the size of the foreground area in an input image 104 that is to be encoded.

If the size of the raw data 102 is larger than the foreground area of the input image 104 then the method may return an error. Optionally, the data 106 may be truncated.

If the raw data 102 retrieved, received, or generated is not already encoded, it may need to be encoded according to an encoding scheme in some embodiments. The encoding step produces encoded data 106 or otherwise in a form ready to encode into the carrier image 100. Alternatively, the raw data 102 may already be encoded data 106 and as such the encoding step 110 does not modify the raw data 102 or the system may not employ the encoding step 110.

Referring to FIG. 1A, encoded data 106 generally comprises a plurality of codewords. These codewords may also be described as characters and/or words. Raw data 102 may be encoded into encoded data 106 using an encoding scheme 112. Encoding schemes 112 use an alphabet. An alphabet is a unique set of codewords. A common representation for data in the form of binary data. Binary is an encoding scheme which uses an alphabet of 0 and 1. Using ASCII, binary may be represented using the characters ‘0’ and ‘1’. Alternatively, binary may be represented using a bit. A bit represents only on and off, which correlates to one and zero.

Some common binary to text encoding schemes are octal, hexadecimal, Base32 and Base64. Binary to text encoding schemes encode data in plaintext. Plaintext may be printable. An example plaintext character set is ASCII.

Other encoding schemes may also be used for example Huffman encoding. Huffman encoding may use a given alphabet, or generate an alphabet when encoding the data.

It will be appreciated by person skilled in the art that different encoding schemes may be used from the ones presented examples in this specification.

In an embodiment, an encoding scheme is defined ahead of time and provided to both an encoder and decoder.

In another embodiment, an encoding scheme may also be selected based on the input data requirements and the input image. More specifically the size of the raw data 102 and the size of a coding area within an image mask may dictate the encoding scheme used.

The encoding scheme 112 and/or size of the alphabet may also be determined by the ability of a device receiving the carrier image to discriminate colours. The encoding scheme 112 and/or size of the alphabet may be a function of the number of different colours to be used in the carrier image. Alternatively, the number of different colours used in the carrier image may be a function of the encoding scheme 112 and/or size of the alphabet. The encoding scheme 112 and/or size of the alphabet may map directly to the number of different colours used in the carrier image 100.

The encoding scheme 112 and/or size of the alphabet may determine the properties of the raw data 102. Alternatively, properties of the raw data 102 may determine the encoding scheme 112 and/or size the alphabet.

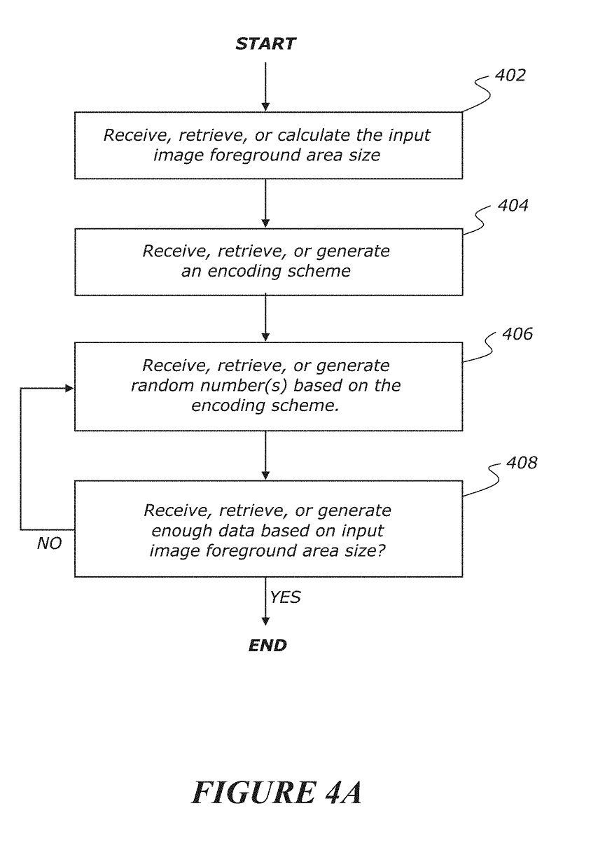

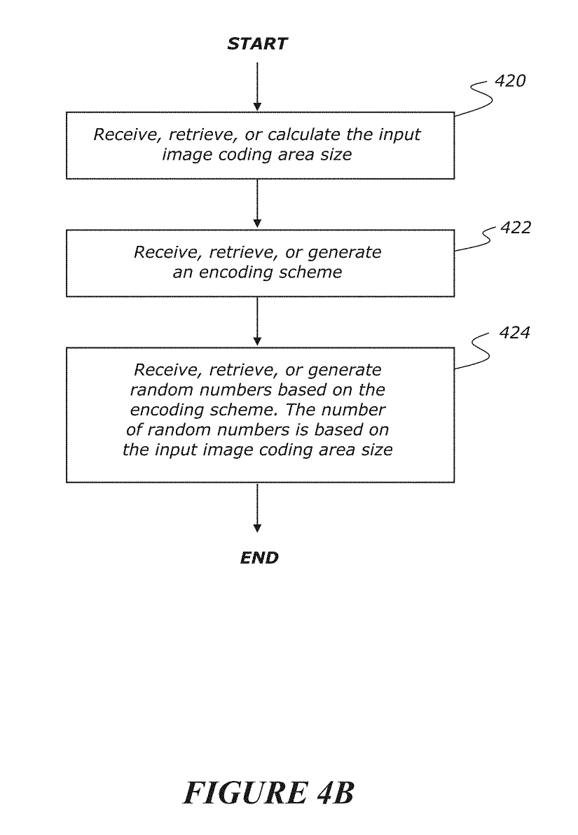

FIGS. 4A and 4B show example methods used to generate the encoded data 106 for insertion use with the carrier image. The example shown in FIG. 4A generates encoded data 106 for each pixel in the coding area. Step 402 determines the size of the coding area of the input image. In this example, the coding area is a foreground area. Then in step 404, an encoding scheme is determined. In step 406, a pseudorandom number is received, retrieved, or generated between a first and a second bound. The number could be generated by a random number generator or other system. The first and second bounds are determined ahead of time. In practice the second bound will be low, however, the second bound is only limited size of the encoding alphabet, for example ASCII. In this example, the second bound is 16. Step 408 will assess whether further pseudo random numbers need to be generated based on the number generated thus far, and the size of the foreground area. The output of this method is an alphanumeric string the same length as the number of pixels in the coding area. Table 1 below shows how pseudo random numbers generated with first bound of 0 and second bound of 15 maps to the following characters in an alphabet of ‘0’, ‘1’, ‘2’, ‘3’, ‘4’, ‘5’, ‘6’, ‘7’, ‘8’, ‘9’, ‘A’, ‘B’, ‘C’, ‘D’, ‘E’, and ‘F’:

TABLE 1
Pseudo-random Number to Character Mapping

| Pseudo Random Number (input) | Character/Codeword (output) |
|---|---|
| 0 | ‘0’ |
| 1 | ‘1’ |
| 2 | ‘2’ |
| 3 | ‘3’ |
| 4 | ‘4’ |
| 5 | ‘5’ |
| 6 | ‘6’ |
| 7 | ‘7’ |
| 8 | ‘8’ |
| 9 | ‘9’ |
| 10 | ‘A’ |
| 11 | ‘B’ |
| 12 | ‘C’ |
| 13 | ‘D’ |
| 14 | ‘E’ |
| 15 | ‘F’ |

As shown in FIG. 4A, the size of the coding area in the input image is known before receiving, retrieving, for generating the data. The size of the area may be received, retrieved, or calculated based on the methods disclosed above. A person skilled in the art will appreciate that there are many alternative known methods of calculating the size of areas within an image, such as, but not limited to, the number of colour units (e.g. pixels or pixel groups).

A variation on the method of FIG. 4A is shown in FIG. 4B. Similar to the example of 4A, step 420 determines the image coding area size and step 422 determines a coding scheme. Step 424 will generate the required number of random numbers (between the bounds). The required number of random numbers is based on the size of the coding area of the input image.

With the coding area's size and the encoding scheme, the data may now be received, retrieved, or generated. The example methods of FIG. 4A and FIG. 4B show the data is received, retrieved, or generated based on random numbers. Alternatively, the data may be based on other number sources, for example TCP/IP session IDs.

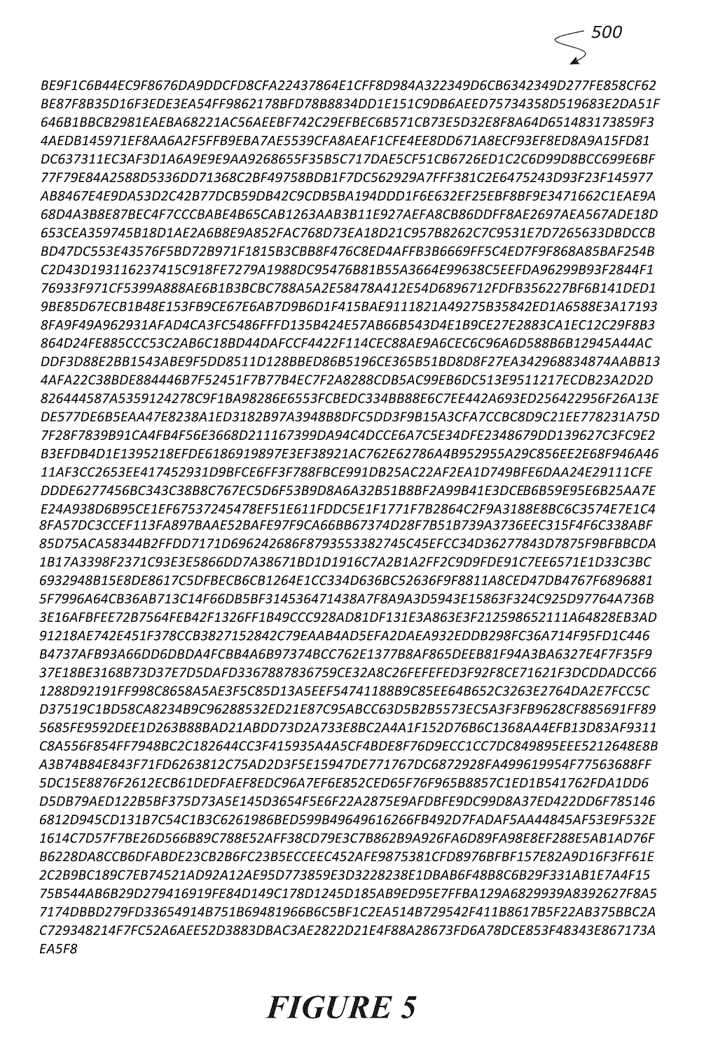

The end result of the methods shown in FIG. 4A and FIG. 4B is a series of random numbers generated. Each random number being between two bounds. The two bounds may be determined based on the encoding scheme. The number of random numbers will equal the number of colour units (e.g. pixel or pixel group) in the coding area. FIG. 5 shows example encoded data 500. The encoded data 500 has been generated based on the encoding scheme presented in Table 1 and the coding area size of 3706. The bounds are one and fifteen. The encoded data may be stored as a string as shown in FIG. 5. A person skilled in the art will appreciate that the encoded data may be stored in any other manner of memory storage. The encoded data 500 will have 15 to the power of 3706 (15̂3706 or 15³⁷⁰⁶) different permutations (or combinations). This encoded data 500 may act as a highly unique identifier because of the large range of combinations available.

Table 1 shows that the alphabet contains character ‘0’ and the encoded data 500 has been generated using a lower bound of one so that codeword ‘0’ has been reserved. This reservation may be useful for use with other areas. As will be described below, the reserved code point may be used with a colour unit that is completely transparent. This may be useful when generating the carrier image as the foreground is generated, pixels, or pixel groups of 100% transparency will allow the background to not be occluded.

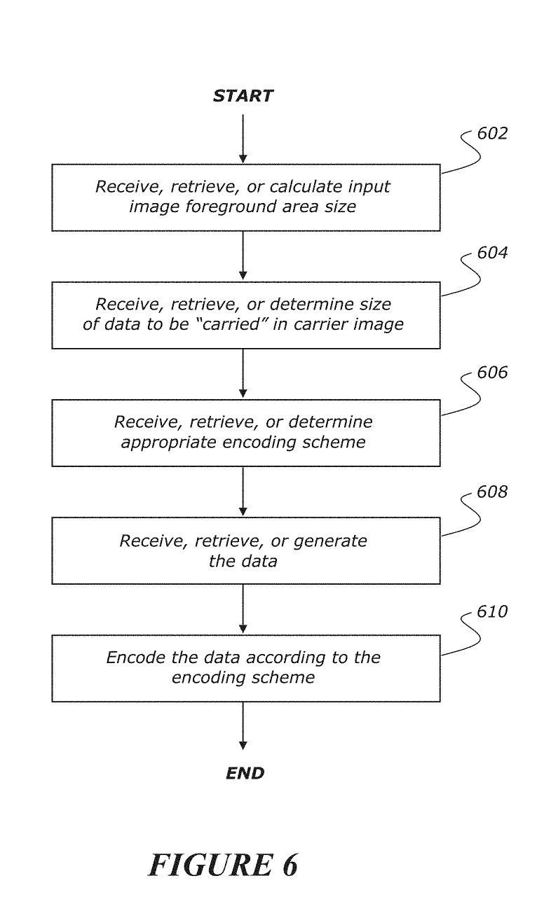

FIG. 6 shows an alternative method in which the encoding scheme is selected based on a required data size and the input image coding area size. In step 602 the input image coding area is determined, in this example the coding area is the foreground of the image. In step 604 the size of the data is determined. The size of the data depends on the application. In an embodiment, the size the data may not be modified or determined by the carrier image generator. The size of the data may be determined by the size of a TCP/IP session ID. In step 606 at appropriate encoding scheme is determined. This encoding scheme is determined based on the coding size and the size of the data. The data may then be received and encoded as shown in step 608 and 610.

For example, using the example brand of FIGS. 2A and 2C, the foreground area size is 10. The data to be “carried” by the carrier image is a number from 0 to 1000. To store a number from 0 to 1000, with a size of ten to store the data, (10 colour units, or pixels in this example) binary encoding may be used, since 10 bits are able to store any number 0 to 1023 using an unsigned number system.

With the binary encoding scheme selected, the data is retrieved, received, or generated. In this example, the number 857 is received as data and this data is to be encoded into the carrier image. This number may be a random number. Using binary encoding, the number may be encoded as “1101011001” if printed as plaintext, the number may also be represented as an integer 857 but stored as 10 bits or 16 bits with 6 leading padding ‘0’ bits.

The carrier image of FIGS. 2B and 2D show two different colours (dark grey and light grey) used in the foreground area. This is a result of binary coding being used. In total three colours are used because the background is a white colour. It will be appreciated that the background and/or foreground may contain other colours depending on encoding scheme 112, raw data 102, encoded data 106, padding data, colour map 108 and input image 104.

A person skilled in the art will appreciate that other encoding schemes may be used, for example octal encoding scheme is also able to encode a number ranging from 0 to 1000 in only 2 codewords/characters. If the encoding scheme selected was octal for the example input image of FIG. 2A then not all of the pixel areas within the foreground area may be required to encode the number. Continuing briefly with the octal example, only two codewords/characters would be required and therefore only two colour units of the foreground be needed to store the data within the carrier image. In this case the remaining foreground pixels may default to the input image's pixels, or non-data-encoding codeword/character may be used. Non-data-encoding codewords/characters work as padding codewords/characters. A person skilled in the art will appreciate that padding is known in encoding schemes and may be required in many different circumstances.

Colour Mapping

Once the raw data 102 has been encoded into encoded data 106 which comprises codewords, each codeword can now be mapped to a colour.

A colour may be in the form of RGB, RGBA, Lab, HSL, Pantone, or any other known colour format or encoding scheme.

A colour map 108 may be used to map codewords to colours. An example colour map is shown in Table 2 below.

TABLE 2
Example Colour Map

| Codeword/Character | Colour (in RGBA hex format) |
|---|---|
| ‘0’ | ‘#FFFFFF00’ |
| ‘1’ | ‘#6C48C2FF’ |
| ‘2’ | ‘#41201FFF’ |
| ‘3’ | ‘#1B6DF9FF’ |
| ‘4’ | ‘#7137C3FF’ |
| ‘5’ | ‘#1EAAE4FF’ |
| ‘6’ | ‘#390231FF’ |
| ‘7’ | ‘#73DAABFF’ |
| ‘8’ | ‘#E45D69FF’ |
| ‘9’ | ‘#01C62EFF’ |
| ‘A’ | ‘#27D550FF’ |
| ‘B’ | ‘#A883F7FF’ |
| ‘C’ | ‘#F679ECFF’ |
| ‘D’ | ‘#CC7312FF’ |
| ‘E’ | ‘#907E4DFF’ |
| ‘F’ | ‘#A6EACAFF’ |

The colour map 108 is represented as a table above. Alternatively, the colour map 108 may be represented and/or stored as an array of colours wherein the codeword indexes the array, or the codeword is a key for the array. Alternatively, the colour map 108 may be represented and/or stored as a set of key-value pairs. Key-value pairs comprise a key and a value. The key may be the codeword and the value may be the colour. This configuration may be useful for generating the carrier image. Alternatively, the key may be the colour and the codeword may be the value. This configuration may be useful for reading the carrier image and then extracting the encoded data.

The colours within the colour map 108 may be selected based on the input image. An operator may manually select or configure the colours for the colour map 108. Alternatively the colours may be generated based on a colour picking algorithm. An example colour picking algorithm may find the dominant colour of the input image and create a number of variations on that colour. The variations of the colour may then be used in the colour map e.g. different transparencies, hues, and/or shades. Another example colour picking algorithm may select colours at random. A person skilled in the art will appreciate that other algorithms may be used for picking a range of colours.

In this embodiment, the colours in the colour map 108 are configured to be visually similar to the colours within the input image such that when the colours have been picked from the colour map the resultant carrier image will look the same or similar to the input image. An image capturing device will still be able to detect any colour variations. The colour map shown in Table 3 provides a colour map that uses visually similar colours to the input image.

Reverting to the examples of FIG. 2A-2D, a colour map in the form of a lighter colour for ‘0’ and a darker colour for ‘1’.

In an alternative embodiment, the colour map 108 comprises colour differences rather than colours. In this way, it may be easier to ensure that the carrier image looks the same or similar to the input image. By using colour differences rather than absolute colours the decoder must store the unmodified input image for comparison with the slightly differing colour units of the carrier image.

Inserting Colours

The carrier image 100 may be generated by modifying the input image 104 directly, or by generating an entirely separate image.

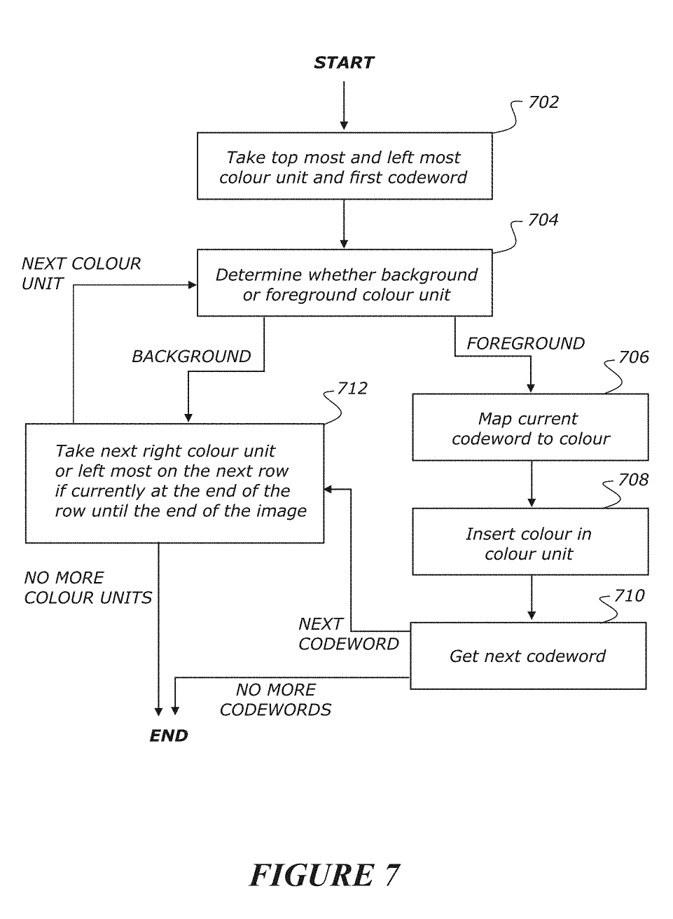

In one embodiment, the number of codewords in the encoded data 106 (i.e. the string of codewords that represents the encoded data) will equal the number of colour units in a coding area of the input image. In this embodiment the coding area colour units are iterated over along with the codewords of the encoded data 106. For example, each codeword in the string is mapped or assigned to a specific colour unit in the coding area of the input image. Each codeword of the string is mapped to its assigned colour using the colour map 108. Each colour unit is then coloured according to the selected colour from the colour map 108 associated with its assigned codeword of the string of encoded data. When iterating over colour units, a left-to-right then top-to-bottom algorithm may be used such as the one described in FIG. 7. A person skilled in the art will appreciate that other area filling algorithms may be used.

The method of FIG. 7 begins with the input image, input image mask, and codewords already determined. Step 702 takes the top left colour unit and selects the first codeword of the encoded data. Then, in step 704, using the image mask data, the area the colour unit belongs to is determined. The area may be a coding area, or a non-coding area. In the example presented in FIG. 7, foreground and background are used. If the colour unit as a foreground colour unit then the current codeword mentioned the colour unit as maps to a colour as shown in step 706. Then in step 708 colour unit is inserted into the carrier image. The next codeword of the encoded data is selected in step 710. If there are no more codewords then the process has completed. If there are more codewords, then the next colour unit is obtained. If the colour unit is a part of, or a member of, or belongs to a non-coding area, such as a background colour unit then the next colour unit is found. The step 712 uses a left-to-right then top-to-bottom approach to getting the next colour unit. There are no more colour units in the carrier image is complete. Similarly, step 712 is used to obtain the next colour unit if the current colour unit of step 704 is a part of, or a member of, or belongs to a non-coding area. In one embodiment, the number of colour units and codewords are equal and as such the method will run out of colour units and codewords at the same time. In another embodiment, if there are more codewords or more colour units an error is raised.

When there are more colour units than encoded data points, padding colour units may be used. Padding colour units do not map to any useful encoded data. Padding colour units only served to fill out the rest of the carrier image.

If there are not enough colour units for the number of codewords in the encoded data 106 then an error may be raised. This error may require the caller to use a smaller data size, select an input image with larger coding area and/or select a different encoding scheme.

Reverting to the examples of FIG. 2A-2D, we can see the number 857 has been encoded using a right-to-left, then top-to-bottom approach. 857 has been binary encoded as “1101011001”. A colour map has been used to map darker colour units to ‘1’, and lighter colour units to ‘0’.

Decoding the Carrier Image

In an embodiment, the process of decoding the carrier image to extract the original data may be the process described above for generating carrier image performed in reverse.

An image capturing device is used to capture the carrier image. The image carrier device may forward on the carrier image and or decode the carrier image.

The decoding device may retrieve, receive, have inputted, have preinstalled, and/or otherwise have stored, the colour map associated with the carrier image. The decoding device may detect the appropriate stored colour map, have the colour map preselected by user, or may only work with one type of carrier image and as such needs only one colour map.

The decoding device iterates over the colour units of the captured image. Using the colour map, the decoding device maps each colour units to a corresponding codeword. The order the decoding device iterates of the colour units may be defined beforehand. For example the decoder may iterate over the colour units left-to-right then top to bottom and assign method is provided above with respect to the colour unit insertion.

The extracted codewords are concatenated with each other into a string in order to generate the “encoded data” string. The encoded data may not need to be decoded as it may already be in a usable, plaintext, and/or human readable form. Alternatively, the data is decoded according to an encoding scheme. For example a hexadecimal encoding scheme may be used.

With the data extracted the decoding device may forward this information on to another device and or use it itself for its own processes. The decoding device may be the same device as the image capture device. Alternatively, the image capture device forwards the captured carrier image onto a decoding device or system. The forwarding may be over a network for example the Internet.

A person skilled in the art will appreciate there are many methods of capturing an image to form a usable image for the decoder. A person skilled in the art will also appreciate that image processing algorithms may be used to clean up the image if required.

If the captured digital carrier image is not suitable for decoding, or the decoding device doesn't have all of the information required, the decoding device may raise an error. The decoder may raise an error for any number of other reasons. For example, the decoder cannot discriminate between the colour units, the decoder doesn't have the correct colour map or encoding scheme, the decoder does not recognise the image, the decoder does not recognise the colours because of external or environmental issues such as brightness, and/or any other image or decoding related problems.

Example Carrier Image Generation A

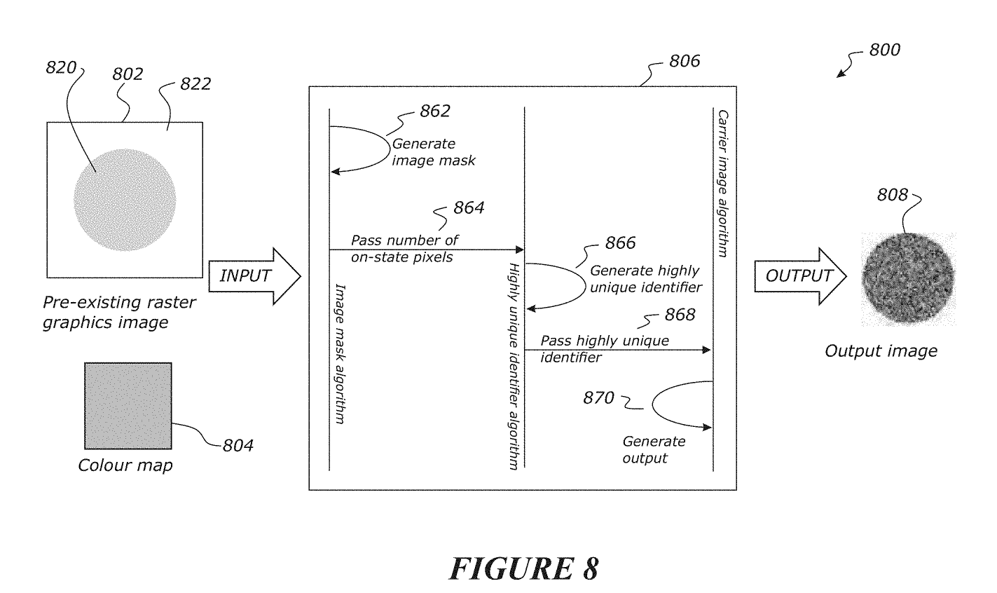

FIG. 8 provides an example carrier image generation process.

The overall process 800 shown in FIG. 8 has two inputs:
a pre-existing raster graphics input image 802, and
a colour map 804.

The encoding scheme is inbuilt and/or pre-existing to the overall process 800. The data is generated within the process 806.

In this example, the process 800 is carrying out part of the carrier image generation system 120 as shown in FIG. 1A. The main difference is that the process 800 generates internally the encoding scheme, data and encoded data, rather than receives or retrieves as an input.

The input image 802 is a rectangular raster graphics image. The input image 802 has two main areas: a circular foreground area 820 and a background area 822. The circular foreground area 820 will be the coding area for the carrier image 808.

The first step 862 in the carrier image generation process 806 is to receive, retrieve, or generate an image mask. The image mask corresponds to the input image 802. The image mask defines the coding area within the input image. The image mask 354 from FIG. 3B is an example corresponding image mask 354 to input image 802. From the image mask 354, the size of the coding area 820 is calculated. The foreground area 820 is described in the image mask 354 using white on-state pixels. The white “on-state pixels” are shown in the coding area 356 of the image mask 354. The size of the coding area 356 correlates to the number of colour units in the coding area (e.g. pixels in the coding area). In this example, the number of on-state pixels is calculated. The on-state pixels define the area of the image which will have colour data inserted (i.e. will be coded with the data). In step 864, the number of on-state pixels is passed to the highly unique identifier algorithm process.

With the size of the foreground of the image known, a highly unique identifier is generated in step 866. The highly unique identifier will be coded into the image. This highly unique identifier comprises a series pseudorandom numbers generated between 2 bounds. The size of the highly unique identifier is the number of on-state pixels. For example if there are 1000 pixels, the highly unique identifier will be 1000 codewords long. In this example, the random numbers numbers generated are between one and fifteen and map, using Table 1, to codewords between ‘1’ and ‘F’. The highly unique identifier is passed to the carrier image algorithm process in step 868.

The step 870 uses the colour map 804 to map the highly unique identifier to colours. The colour map of Table 2 is used here.

The process 806 will then generate the output image. For each on state pixel, an X-Y position is recorded, and processed. The pixels are enumerated. Their enumeration and/or order is used to reference a character in the highly unique identifier. In other words, the fourth on state pixel to be processed uses and/or references the fourth character of the highly unique identifier.

When iterating over the on-state pixels, it's done in a left-to-right and then top-to-bottom fashion. A person skilled in the art will appreciate that other filling patterns may be used, for example a spiral, right-to-left, bottom-to-top, or any combination thereof.

The referenced character is mapped to a colour via the colour map 804. The pixel of the appropriate colour is inserted at the previously recorded X-Y position on the new raster graphics image. The resultant raster graphics image is the carrier image 808. Alternatively, the input image or the image mask themselves may be modified and have pixels inserted or overlayed.

Example Carrier Image Generation B

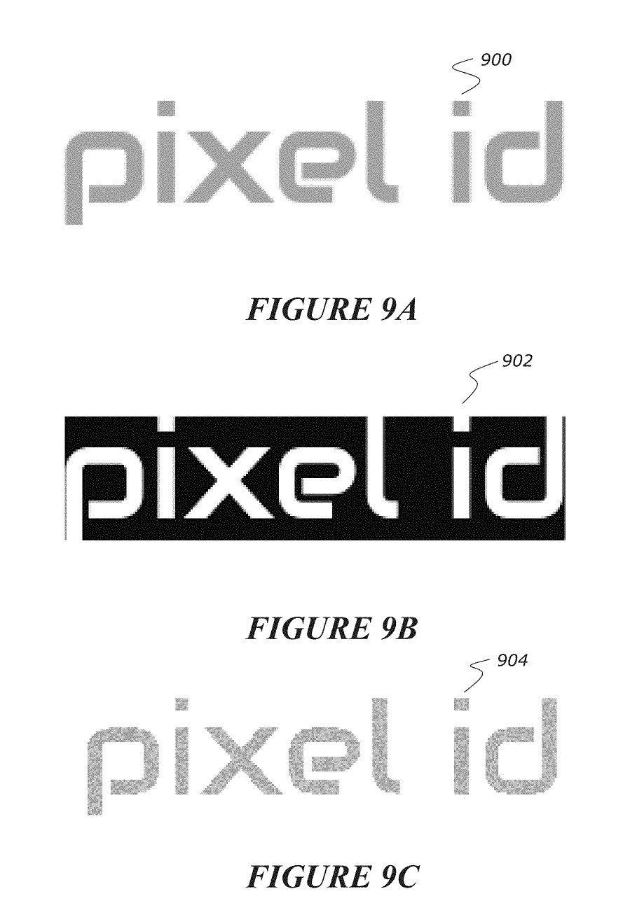

FIGS. 9A through 9C show a further example demonstrating a similar process to that of FIG. 7.

FIG. 9A shows a brand 900. In this example the brand is two words. The two words are stored as an image rather than plaintext for this example.

FIG. 9B shows an example image mask 902 associated with the brand 900. The image mask is calculated ahead of time.

In this example the number of colour units is 3363. The image mask 902 uses on state pixels to define the colour unit.

A series of pseudorandom numbers are generated. In this example binary encoding is used and as such the pseudorandom number will generated will be 1 or 2. Person skilled in the art will appreciate that this is merely a representation chosen for clarity, other random numbers could be used. The random numbers generated are mapped to the codewords ‘1’ and ‘2’. An example highly unique identifier may result in something of the form (the full-length of the string is not shown here for brevity): “122112122121212112 . . . ”. The highly unique identifier will be 3363 codewords long.

Table 3 is chosen to closely match the original colour(s) of the brand 900. The ‘1’ character is matched to the colour of corporate logo. The ‘2’ character is mapped to an RGBA value equivalent to 60% transparency level applied to the colour of the corporate logo.

TABLE 3
Example Colour Map

| Codeword/Character | Colour (RGBA hex format) |
|---|---|
| ‘0’ | ‘#FFFFFF00’ |
| ‘1’ | ‘#FF8C8EFF’ |
| ‘2’ | ‘#FF8C8E99’ |

FIG. 9C shows the carrier image 904. The carrier image 904 is generated based on the colour map and the highly unique identifier.

This example highlights that different colours need not always be used. In this example only the transparency is changed between pixels: 100% (#FF) for ‘1’ and roughly 60% (#99) for ‘2’. The colour (#FF8C8E) remains the same for each codeword used in encoding the data.

In another embodiment, it will be appreciated that both transparency and colour may be changed.

The carrier image 904 very closely resembles the original brand 900, enabling it to be substituted for the original brand 900 and allows the highly unique identifier to be “hidden in plain sight”.

Applications

Several applications or use cases for the carrier image generation scheme are possible.

In many cases, a colour mapping table is utilised to map the colours of the carrier image to the data of the carrier image. The colour mapping table may be known ahead of time, inputted by a user, received or retrieved over the network, inferred from the carrier image, and/or any combination of the proceeding.

Similarly, an encoding scheme may be utilised. This encoding scheme may be known ahead of time, inputted by a user, received or retrieved over the network, inferred from the carrier image, and/or any combination of the proceeding.

Remote Biometrics

One application is to enable remote biometrics for systems, devices, applications, or similar that do not have built-in biometric sensors. For example, a desktop PC. In this application, a second network connected device such as a smartphone, is used for biometric input. A carrier image is generated based on data, for example a highly unique identifier. The carrier image is displayed on the desktop PC. The carrier image and the biometric input are both captured on the smartphone. Since the proximity to the desktop PC (via an image capture of the carrier image) can be established, the biometric data and the carrier image data to be forwarded to the relevant system associated with the desktop PC requiring biometric input.

A non-exhaustive list of example biometric inputs may be fingerprint scan, retina scan, and facial recognition.

Transfer of Information

Another application is the transfer of information. This information could be transferred via email, print, and/or any other way to display an image. The data carried by the carrier image may be a highly unique identifier for use as a serial number and/or database ID to look up further information later. Alternatively the data carried by the carrier image may be the information required itself. For example the information may be a URL and the data carried by the carrier image encodes the URL in plaintext.

For example, a carrier image may be provided via an email. The carrier image may encode customer information. Customer information may include sundry information related to a customer, for example registration numbers, customer id numbers, phone numbers.

Optionally, the data of the carrier image is a highly unique identifier. Also provided is a map to map the highly unique identifier to a customer number.

In another example, the carrier image may work in a similar method as a QR code. This use may be useful for when a QR code is deemed too intrusive because of its size and/or aesthetic. Typically, QR codes are used to encode website URLs and/or item serial numbers. A person skilled in the art will appreciate that QR codes are able to encode any arbitrary data. URLs are used by way of example only. Other example uses may include promotional material, voucher codes, stock control, geo-tagging. The carrier image may perform this function by way of a URL mapping table and/or encoding the URL data directly. If a URL mapping table is used the URL map may be predetermined and/or received or retrieved from a remote server.

Identification and Verification

Other application may be in the use of identification and verification. The case of physical items (objects) where multilayer identification is required, a carrier image provides a way to identify and verify the physical item. Scanning the carrier image allows the user to retrieve the data. The data may be a highly unique identifier. Example usages may be in passports, drivers licenses, security cards, and/or currency.

### EXAMPLE 1

### Image Generation System and Network Authentication

Also described is an image generation system and method for network authentication. In this system, an image is used to uniquely identify a browsing session. The browsing session may be identified by a TCP/IP connection or other session data. An example of a TCP/IP connection or session is one created when an HTTP client or web browser connects to a server. The image is generated once per session. Alternatively, the image may be generated once per user, or once per webpage load, once per requesting device or any other frequency.

The method of generating the image broadly comprises any one or more of the following steps, in any combination and/or order:
receiving or retrieving a pre-existing image, optionally from the website,
receiving, retrieving or generating data,
generating a carrier image based on the pre-existing image and the data (where in the carrier image carries the data), and/or
inserting or rendering the carrier image into the website for display.

In one example, the pre-existing image is a brand and that the brand reflects the brand of the website provider. A brand may be a logo, an image, text, a combination of image and text, and/or other asset capable of visually identifying a company, good and/or service. Alternatively, the pre-existing image may be a button, GUI element or other imagery or element displayed on the website.

A person skilled in the art will appreciate that authentication may be in the form of logging in to a website. For many websites, authentication begins with providing a login name, such as a username, and a password. A username and password may more generally be called user credentials, or user data. If correct user credentials are provided, then a user is logged in, or authenticated. A person skilled in the art will appreciate that while a username and password log in systems are provided in some examples, the example systems described may work or be extended to more general authentication systems. User credential and/or user data may also extend to other user identifying information including public or private keys.

Example System

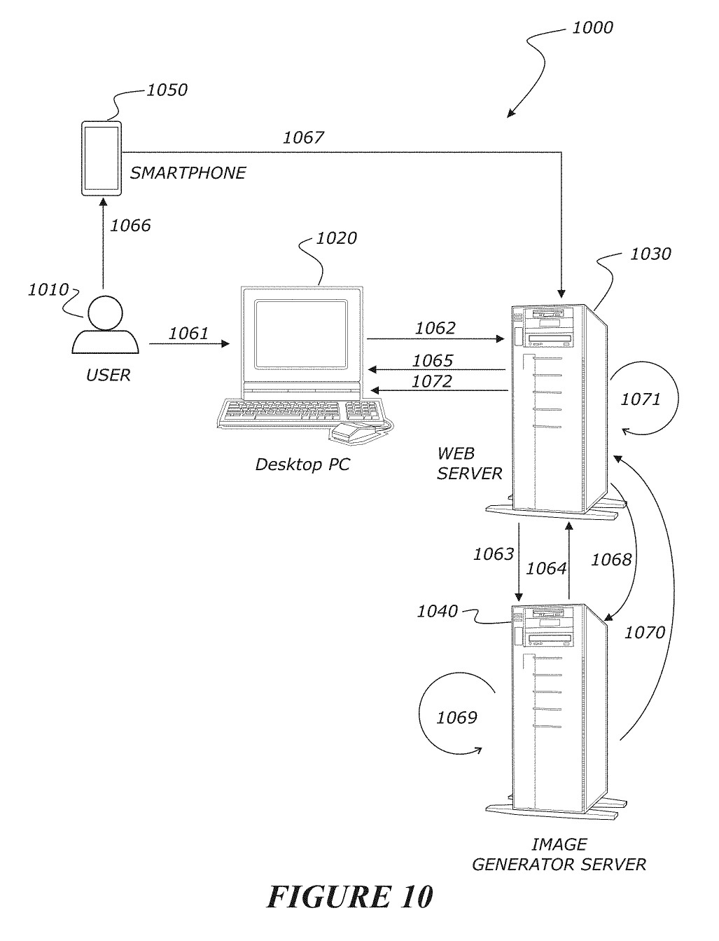

FIG. 10 shows an example network authentication system. The network authentication system in this example comprises a user 1010, a desktop 1020, a web server 1030, and image generation server 1040, and a smartphone 1050.

In this example, an associated method of this system may follow the following steps:
1061. A user 1010 opens a web browser on the desktop PC 1020.
1062. The user 1010, using the web browser, requests a website from the web server 1030. The website requested contains a login interface. The request sent by the desktop PC 1020 may be in the form of an HTTP request.
1063. The web server 1030 makes a request to the image generation server 1040 to generate a carrier image.
1064. The image generation server 1040 responds to the web server 1030 with a carrier image, which carriers or is encoded with carrier image data. The carrier image data uniquely identifies the web browser session of the web browser of the desktop PC 1020. In this example, the carrier image data is in the form of a highly unique identifier.
1065. The web server 1030, in response to the web browsers request, returns the website which comprises a login interface rendering or displaying on the desktop PC 1020. This response may be in the form of an HTTP response. The HTTP response may comprise HTML, images, or other web related assets. Multiple HTTP response may be used for multiple different assets. The login interface comprises the carrier image. The carrier image is now visible to the user 1010, although the carrier image data is “hidden in plain sight” to the user 1010.
1066. The user 1010 is authenticated to an application on the smartphone 1050 and captures the carrier image with the smartphone 1050. In one embodiment, the smartphone application authentication is done using a biometric input sensor and/or biometric data. In an alternative embodiment, the smartphone authentication is done with a PIN input, password input, or other smartphone authentication systems. The smartphone comprises user data. This user data may include a username and password for the website being accessed on the web browser on the desktop PC 1020.
1067. The user data and carrier image data is sent to the web server 1030. The carrier image data may comprise the carrier image itself and/or the data carried within the carrier image (i.e. the highly unique identifier in this example).
1068. The web server 1030 forwards the carrier image data to the image generation server 1040.
1069. The image generation server 1040 verifies the carrier image data. The verification process involves recovering the carrier image data. In this example, the verification process
1070. The image generation server 1040 indicates to the web server 1030 that the carrier image data is correct and/or verified. Optionally, the web server 1030 may also receive or retrieve, from the image generation server 1040, the carrier image data to identify the browser session.
1071. The web server 1030 authenticates the user 1010 based on the user data and optionally the carrier image data.
1072. The web browser on the desktop PC 1020 is redirected and logged into the website being served by the web server 1030.

A person skilled in the art will appreciate the directions of dataflow above are exemplary only. The data may be received or retrieved in different directions and/or from different sources.

In this example, the web server 1030 may be serving a website of a bank. The bank may also provide the smartphone application running on the user's 1010 smartphone 1050. This way, the user data stored on the smartphone 1050 may be protected using the bank's own smartphone application.

Because the carrier image generated is different every time a user 1010 opens a browser session to the web server 1030, carrier image data must be captured every time a new browser session is started. Therefore, user 1010 must be proximate to the desktop PC 1020 with their smartphone to use this login system and method. When the web server 1030 receives and verifies the user data and carrier image data, the web server is able to authenticate the user's browser session on the desktop PC 1020.

Optionally, the carrier image generated is not different every time a new browser session is started. The carrier image may be re-generated at different time frequencies, after session timeouts, or any other appropriate events.

In this example, the smartphone application captures the carrier image and stores it as carrier image data. The carrier image data may be any known image storage format, including JPEG, PNG, and/or GIF. The image generation server 1040 verifies the carrier image data by decoding the carrier image. In this way, the carrier image data is representative of the carrier image. In one embodiment, the smartphone application decodes the captured image of the carrier image to generate the carrier image data. This way, the image generation server 1040 does not need to decode the image and can compare the raw data of the carrier image for verification. In this embodiment, the carrier image data is indicative of the data carried by the carrier image. A person skilled in the art will understand that image data may be processed in different locations depending on device processing power, and availability of resources.

In one embodiment, the network authentication system and method 1000 is used alongside traditional login methods. Traditional login methods include submitting username and password data.

In one embodiment, the web server 1030 and image generation server 1040 are separate pieces of hardware. In another embodiment, the servers are running on the same hardware as different processes. In another embodiment, the servers are running on the same hardware as different virtual machines. A person skilled in the art will appreciate that a number of different configurations may be used for running software.

This login system may be used with any web enabled technology that requires logging in, for example, banking, finance, telecommunications, retail, utilities, or technology. From a user's perspective, the method and system provide a way to use biometric input (via their smartphone) to login to a system that does not have biometric input capability. This login system may extend to any other logging in/authentication systems that do not have biometric sensors.

The example system as shown in FIG. 10 shows only the “happy path”. If at any time an error is detected and/or incorrect login information is provided then the relevant device or server that locates the error may raise the error and/or report back to the another device or server. For example if the verification step 1069 finds that the image is not correctly verified then the image generation server may report to the web server that the carrier image has failed to be correctly scanned. The web server may report this information to the smartphone 1050 or to the desktop PC 1020.

Image Generation Server

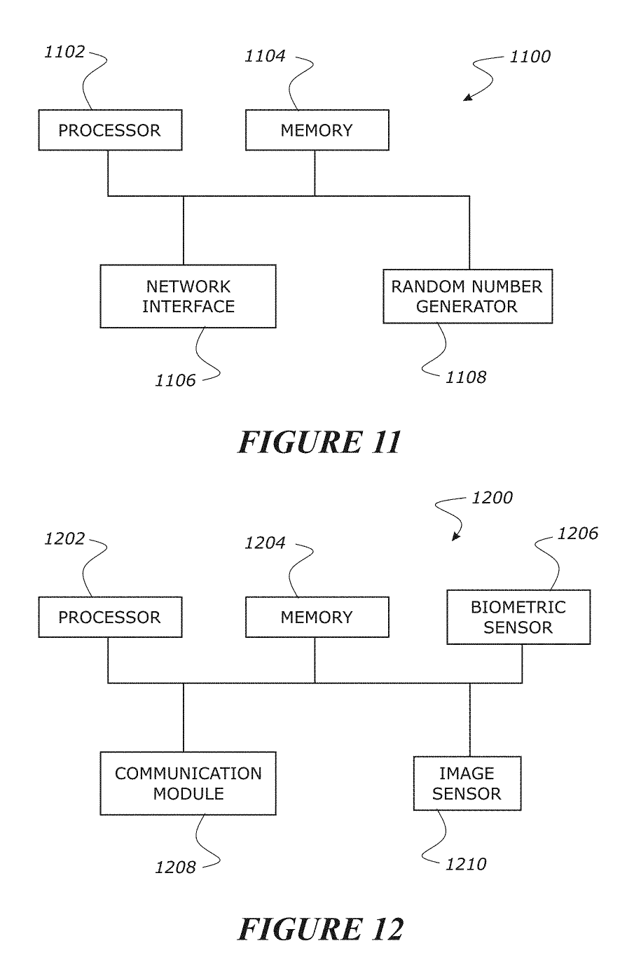

An example image generation server 1100 is shown in FIG. 11. In this example, the server is a physical piece of hardware configured to run an image generation algorithm.

The image generation server 1100 comprises a processor 1102, a memory 1104, and optionally a network interface 1106, and optionally a random number generator (RNG) 1108.

The processor 1102 is configured to run instructions stored in the memory 1104. The instructions stored in the memory 1104 are to implement the image generation method. The memory 1104 may also serve as storage for any one or more of the following:
user data, comprising user credentials,
session data or highly unique identifier data,
data to map session data to highly unique identifier data or vice-versa,
colour map(s),
encoding scheme(s),
captured images,
pre-existing images, and/or
created images.

The communications module 1106 may be any known network interface. Optionally the communications module is an Inter-Process Communication (IPC) module. A non-exhaustive list of examples of network interfaces are: Ethernet, Wi-Fi, Bluetooth, and/or RS-232. The network interface 1106 is configured to establish communication channel is with a web server or any other remote device. The communication channel may be used to transfer images, data and/or other signals. Other signals may include verification signals.

The random number generator 1108 may be used for generating random numbers. Random numbers may be used in the image generation method. In some embodiments the data used in a carrier image is randomly generated. In the example of FIG. 10, the carrier image data is a highly unique identifier. This highly unique identifier is associated with the login session of the user 1010 on the web browser on the desktop PC 1020. In other embodiments the data used in the carrier image is received or retrieved from the web server for example, such as an HTTP session, TCP/IP session, or other web server session identification methods.

In one embodiment, the image generation method may be that of the carrier image generation method described above the reference to FIGS. 1 to 9C. A person skilled in the art will appreciate how to match the inputs of that method with the inputs of the image generation server. For example the input image 104 may be the pre-existing website image.

In another embodiment, the image generation method may be any other known steganography technique.

In an alternative embodiment, the image generation server may be a process running on shared server hardware. In this embodiment, the image generation server may be running on the same hardware as the web server.

In an alternative embodiment, the image generation method running on the image generation server 1040 may be a software library, an API, a REST API, or other loadable software.

In an alternative embodiment, the image generation server may be implemented as a web server plugin.

A person skilled in the art will appreciate there are many different ways to run and/or integrate with software and/or a server's services.

Pre-Existing Website Image and Carrier Image

In one example, when the carrier image is generated based off a pre-existing image, the carrier image will look the same or similar as the pre-existing image. This may be achieved using the example carrier image generation method of FIGS. 1 to 9C or alternatively another stenography image generation technique.

Depending on the requirements, the pre-existing image may be provided to the carrier image generation system once per pre-existing image or once per carrier image being generated. The pre-existing image in this example is a pre-existing website image, such as the logo of the website.

In the example shown in FIG. 10, the pre-existing website image is provided just once before the steps 1061 to 1072 occur. In this way, the number and size of interactions between the web server and the image generation server can be reduced because the pre-existing website image does not need to be sent multiple times.

The web server is configured to receive or retrieve the carrier image generated by the image generation server. The web server may insert the carrier image into a position within the website. This position may be defined by a tag within the websites HTML or coordinate system. Alternatively, the web server may have a pre-existing location for the pre-existing website image. In this case the carrier image is put in the same position as where the pre-existing website image would have gone.

In an embodiment, the process of inserting the carrier image includes inserting a reference to the carrier image. For example, the web server 1030 may use the HTML “<img>” tag to refer to the carrier image. The <img> HTML tag may include a URL or other reference to an image. The desktop PC 1020 will be directed to download the carrier image from the URL presented in the <img> tag. The <img> tag may refer to an image stored on the image generation server 1040. In this case, the desktop PC will download the carrier image from the image generation server and insert the carrier image in the website provided by the web server.

The pre-existing website image may never be intended for use with the website itself. It may be purely for use with the image generation server to create carrier images which will be used in the website.

The carrier image may be decoded by a user device 1050, a web server 1030, the image generation server 1040 itself, or any other device capable of decoding a carrier image.

User Interaction

From the user's perspective, this image generation system and network authentication system provides a simple way to log in to a website. In the example of FIG. 10, the user 1010 uses a smartphone 1052 to:
capture an image of the carrier image,
capture biometric input or other password/login data (e.g. pin) for an application program associated with the image capture functionality, and
transmit user identification data and carrier image data.

The device a user 1010 uses need not be a smartphone. For example, FIG. 12 shows a user device 1200 which may be used.

The user device 1200 comprises a processor 1202, memory 1204, an image sensor 1210, and a communication module 1208. Optionally, the user device 1200 may also comprise a biometric sensor 1206.

The processor 1202 is configured to run instructions stored in the memory 1204. The instructions stored in the memory 1204 are to implement the image capture and data transmission of the user device to the web server and/or image generation server. The memory 1204 may also serve as storage for any one or more of the following:
user data, comprising user credentials,
colour map(s),
encoding scheme(s),
images being captured,
pre-existing images, and/or
images being decoded.

The image sensor 1210 is used similarly to any standard image sensor. It is able to capture images. The sensor 1210 is used to capture the carrier image. The image sensor 1210 and/or the processor 1202 may implement image processing algorithm(s) to decode captured images. The image processing algorithm(s) may be the decoding algorithm of the examples provided above, or any known steganography decoding systems.

The communication module 1208 is used to establish communications with any other device. The communication may be established via a communication link. The communication link may be over the Internet. A non-exhaustive list of examples of communications modules are: Ethernet, Wi-Fi, Bluetooth, and/or RS-232.

The biometric sensor 1206 may be in the form of a fingerprint reader. The user device 1200 may have stored biometric data of the user. When the biometric sensor 1206 is being used, the biometric that has been sensed may be compared to the stored biometric data of the user. The biometric sensor may be used in conjunction with an application of the user device 1200.

The user device 1200 may run an application. The application may implement the steps of the smartphone of the example in FIG. 10. The steps may be any one or more of the following and in any order:
capture an image of the carrier image,
decode the carrier image,
capture biometric input, and
transmit user identification data and carrier image data.

The user device 1200 may use the image sensor 1210 to capture carrier image, the processor 1202 to decode the carrier image, the biometric sensor 1206 to receive a metric information, the memory 1204 to store the user identification data, and the communication module 1208 to transmit the data required to a remote device.

The user identification data may be input into the app and stored for later retrieval. Optionally the application may have the user information pre-installed.

In one configuration, the logging in experience, from a user perspective, follows the following steps:
1. Accessing a website on a first device. The website may comprise a login section, to log into the website.
2. The website is displayed on the first device. The website comprises a carrier image. The carrier image may be part of the login section.
3. The user, using the application on the user device, captures the carrier image presented on the first device, and provides biometric input.
4. Assuming the carrier image is decoded correctly and the application on the user device as stored in the correct user information, the user is automatically logged into the website on the first device.

This login process provides a seamless alternative to the usual typing login credential method. The login process provided here is further improved by use of the carrier image that looks the same or similar to the brand associated with a website the user is logging into. This gives a pleasing experience to the user.

The examples provided relate to a user logging into a website. These is provided as examples only. A person skilled will appreciate that this similar system may be used for any graphical display including non-website related interfaces, such as native applications and kiosks.

Browser Session Identification

In one embodiment, the carrier image “carries” data which identifies a browser session, or is capable of identifying a browser session. In the example shown in FIG. 10, the carrier image is displayed on the user's 1010 desktop PC 1020. The carrier image data identifies the web browser session on the desktop PC 1020. The information required to identify a browser session, or “session data” more generally, may be any one or more of the following:
HTTP session data,
browser cookie data,
TCP/IP session data,
cookie data,
user provided information,
highly unique identifier, and/or
other generated information.

The browser session may involve a user attempting to login, or a future attempt to login. The data used to identify an individual's login attempt or future login attempt can be called “session data”. The session data may comprise a session ID. The session ID may map directly to a TCP/IP session ID and/or TCP port number. These port numbers are generated randomly when establishing new TCP/IP connections. As such, they may serve as a useful way to identify an individual connection to the web server.

In one embodiment of the carrier image data is a highly unique identifier. In this embodiment, the highly unique identifier is mapped to a user's “session data”. The image generation server 1040, or the web server 1030 may store the highly unique identifier, and the session data it is associated with.

### EXAMPLE 2

### Authentication to Access Application Program

In another application or example, the system may be configured to allow authentication, logon, or access to application programs running on any programmable device having an associated electronic display screen or screens. In particular, application programs, such as custom software, smartphone or tablet applications, or smart television applications, are typically operable via graphical user interfaces displayed on an electronic display screen or screens integral with or operatively connected to the hardware device running the application program. It will be appreciated by a skilled person that the system configuration of example 1 for website login or access can be adapted or modified for use in login or access to any application program having an associated displayed graphical user interface.

For example, the system may comprise a user accessing an application program via a first user hardware device (e.g. computer, laptop, gaming console, smart television, or any other programmable device having or being operatively connected to an electronic display screen), a remote server or servers in data communication with the hardware device and application program over a data network (e.g. internet), and a second user hardware device (e.g. smartphone or tablet or other device having an image capture sensor).

This application program system operates similarly to the website login of Example 1, as will be appreciated by a skilled person. For example, the user initiates the application program on their first user device (e.g. smart television or gaming console), and the server generates a carrier image for display on the graphical user interface of the display associated with the first user device. The user then captures an image of the displayed graphical user interface with the carrier image, and then interacts with the server to enable automated login or access to the application program in a similar manner to that described with respect to the website login Example 1.

By way of example only, the application program may be a smart television application program such as a streaming media (audio or video) service or application which operates via display of an associated graphical user interface on a smart television and requires user login or authentication before the user can access content. In another example, the application program may be an online store, such as a game center store associated with games or gaming content or features of a gaming console, the online store presented via a graphical user interface on the display screen (e.g. television or computer screen or other electronic display) and which requires user login or authentication before the user can make online purchases or interact with the store.

General

In the foregoing, a storage medium may represent one or more devices for storing data, including read-only memory (ROM), random access memory (RAM), magnetic disk storage mediums, optical storage mediums, flash memory devices and/or other machine readable mediums for storing information. The terms “machine readable medium” and “computer readable medium” include, but are not limited to portable or fixed storage devices, optical storage devices, and/or various other mediums capable of storing, containing or carrying instruction(s) and/or data.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated in the figures may be rearranged and/or combined into a single component or embodied in several components without departing from the invention. Additional elements or components may also be added without departing from the invention. Additionally, the features described herein may be implemented in software, hardware, as a business method, and/or combination thereof.

In its various aspects, the invention can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

The foregoing description of the invention includes preferred forms thereof. Modifications may be made thereto without departing from the scope of the invention as defined by the accompanying claims.

1. A method of authenticating a user, comprising the steps of:
receiving or retrieving a request from a first user device for access to a website or access to an application program having an associated operable graphical user interface,
generating a carrier image, the carrier image comprising data identifying the request,
transmitting or sending website data or graphical user interface data of the application program to the first user device, the website data or graphical user interface data comprising the carrier image,
receiving or retrieving carrier image data from a second user device, the carrier image data captured by the second user device and the carrier image comprising at least the data identifying the request, and
authenticating the user to access the website or application program based on the data identifying the request.

2. A method according to claim 1 wherein the first user device receives the carrier image and website data or graphical user interface data.

3. A method according to claim 1 wherein the first user device displays the website or graphical user interface of the application program.

4. A method according to claim 1 wherein the first user device displays the website comprising the carrier image or graphical user interface comprising the carrier image.

5. A method according to claim 1 wherein the first user device is any one of: a desktop PC, smartphone, tablet, laptop, television, gaming console, or any other programmable device comprising a display screen.

6. A method according to claim 5 wherein the desktop PC, smartphone, tablet, laptop, television, gaming console, or any other programmable device comprising or operatively connected to a display screen, is used to initiate the request.

7. A method according to claim 1 wherein the website or graphical user interface comprises a reference to the carrier image.

8. A method according to claim 1 wherein the second user device comprises an image sensor.

9. A method according to claim 8 wherein the second user device captures the carrier image using an image sensor of the second user device.

10. A method according to claim 1 wherein the second user device captures the carrier image from the display screen of the first user device.

11. A method according to claim 1 wherein the second user device stores the captured image in memory.

12. A method according to claim 1 wherein the second user device extracts carrier image data from the captured carrier image.

13. A method according to claim 1 wherein the carrier image data is data representative of the carrier image.

14. A method according to claim 1 wherein the carrier image data is the data representative of the request.

15. A method according to claim 1 wherein the second user device is a smartphone or tablet, or any electronic device comprising an image capture sensor or sensors.

16. A method according to claim 1 wherein the second user device transmits the carrier image data to a remote server.

17. A method according to claim 1 wherein the second user device transmits user data relating to the website or application program.

18. A method according to claim 17 wherein the user data is login credentials for the website or application program.

19. A method of storing data within an image, comprising the steps of receiving or retrieving an input image, receiving or retrieving or generating the data, retrieving, receiving, or generating image mask data, wherein the image mask data comprises data indicative of a coding area of the input image, and generating a carrier image based on the input image and the data, wherein the carrier image encodes the data in the coding area of the input image.

20. A method of decoding carrier image data from a carrier image comprising the steps of receiving or retrieving the carrier image, extracting the carrier image data, and transmitting the carrier image data to a remote device.
